(19) United States
(12) Patent Application Publication
(10) Pub. No.: US 2006/0057337 A1
(43) Pub. Date: Mar. 16, 2006

(54) Decorative and ornamental ribbons for diverse finalities

(75) Inventor: Fernando Antonio Suzigan, Nova Odessa (BR)

Correspondence Address: KELLEY DRYE & WARREN LLP, TWO STAMFORD PLAZA, 281 TRESSER BOULEVARD, STAMFORD, CT, 06901, US

(73) Assignee: Progressa Hudtelfa LTDA

(21) Appl. No.: 11/134,087

(22) Filed: May 20, 2005

(30) Foreign Application Priority Data
Sep. 10, 2004 (BR) PI 0403901-7

(51) Int. Cl. B32B 23/02

(52) U.S. Cl. 428/194

(57) ABSTRACT

Decorative and ornamental ribbons for diverse finalities are disclosed in which the decorative and ornamental ribbons are comprised of a first consolidation, the main one, and three variant consolidations that keep among themselves the same characteristics of the main consolidation, having in common the fact of being composed of two or more textile and/or thermoplastic plan sub-extracts strip cutting overlaid and edge-joined by the ultrasound welding or any other possible process or mechanism (for example: gluing, etc.), containing one or more continuous metallic elements or textile threads between the welding and the joining system, with or without internal filling of fibers or natural textile threads, artificial or synthetic textile threads and/or natural seeds and/or paper, plastic and the like, luminous devices, such as incandescent lights, LEDs, optical fibers, etc., in a continuous or fragmented form.

### CROSS REFERENCE TO RELATED APPLICATION

The present application relates to and claims priority from Brazilian Patent Application No. PI 0403901-7, entitled, “DECORATIVE AND ORNAMENTAL RIBBONS FOR DIVERSE FINALITIES,” filed Sep. 10, 2004, which application is hereby incorporated by reference in its entirety.

### BACKGROUND OF THE INVENTION

### Field Of The Invention

The present invention relates to decorative and ornamental ribbons for diverse finalities such as workmanship, decorations, ornamentations, gifts, etc., with innovative characteristics in the field, providing that common ribbons in textiles, non-textiles, or any synthetic surface (base) which allow the ultrasound welding obtained through the strip cutting become ribbons of high visual and aesthetic effect that provide a series of inherent advantages to its applicability.

### SUMMARY OF THE INVENTION

The decorative and ornamental ribbons that are the subject of the invention are comprised of a first consolidation, the main one, and three variant consolidations that keep among themselves the same characteristics of the main consolidation, having in common the fact of being composed of two or more textile and/or thermoplastic plan sub-extracts strip cutting overlaid and joined by the ultrasound welding system, or any other possible process or mechanism (for example: gluing, etc.), containing one or more continuous metallic elements or textile threads between the welding and the joining system, with or without an internal filling of fibers or natural textile threads, artificial or synthetic textile threads and/or natural seeds and/or paper, plastic and the like, in a continuous or fragmented form.

### BRIEF DESCRIPTION OF THE DRAWINGS

The decorative and ornamental ribbons that are the subject of the present invention are shown in the attached illustrative drawings, to which references are made in order to better explain the following detailed description.

FIGS. 1, 2 and 3 represent the first consolidation, the main one, for the decorative and ornamental ribbons, respectively before the assembly, in stage of assembling, and in the final form;

FIG. 4 represents a variant for the decorative and ornamental ribbons from the preceding figures;

FIGS. 5 and 6 represent the second consolidation for the decorative and ornamental ribbons, respectively in stage of assembling and in the final form;

FIG. 7 represents a variant of the second consolidation for the decorative and ornamental ribbons;

FIG. 8 represents a third consolidation for the decorative and ornamental ribbons, which is one part in stage of assembling and another part in the final form; and

FIGS. 9 and 10 represent a fourth consolidation for the decorative and ornamental ribbons, respectively in perspective and profile.

### DETAILED DESCRIPTION OF THE INVENTION

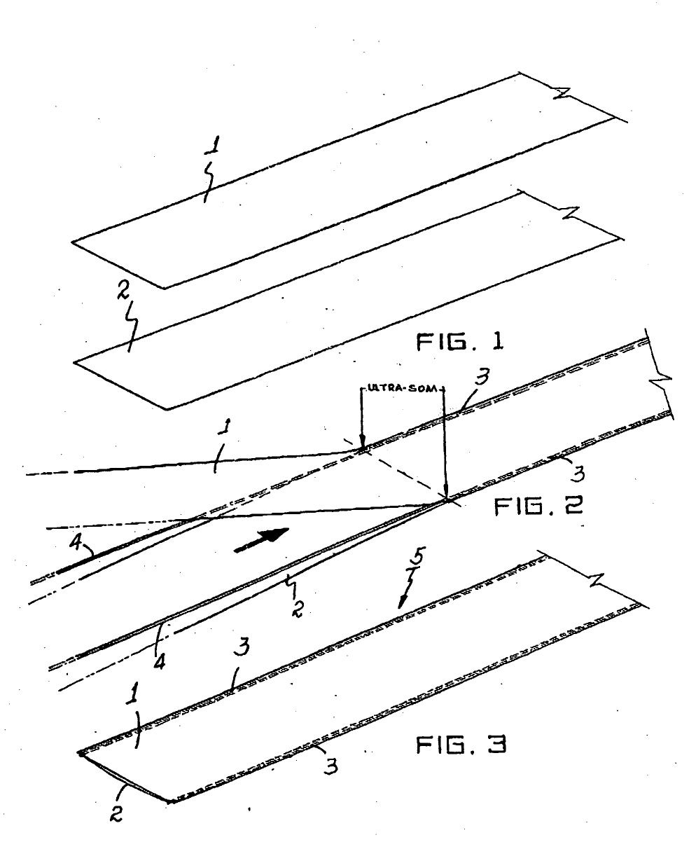

According to what is concluded from FIGS. 1, 2, and 3, a first consolidation for the decorative and ornamental ribbons now proposed is characterized by comprising two textile and/or thermoplastic plan sub-extracts strip cutting 1 and 2 that are overlaid among themselves and edge-joined by the ultrasound welding system 3 or any other possible process or mechanism (for example: gluing, etc.), and can contain one or more continuous metallic elements or textile threads 4 between the welding.

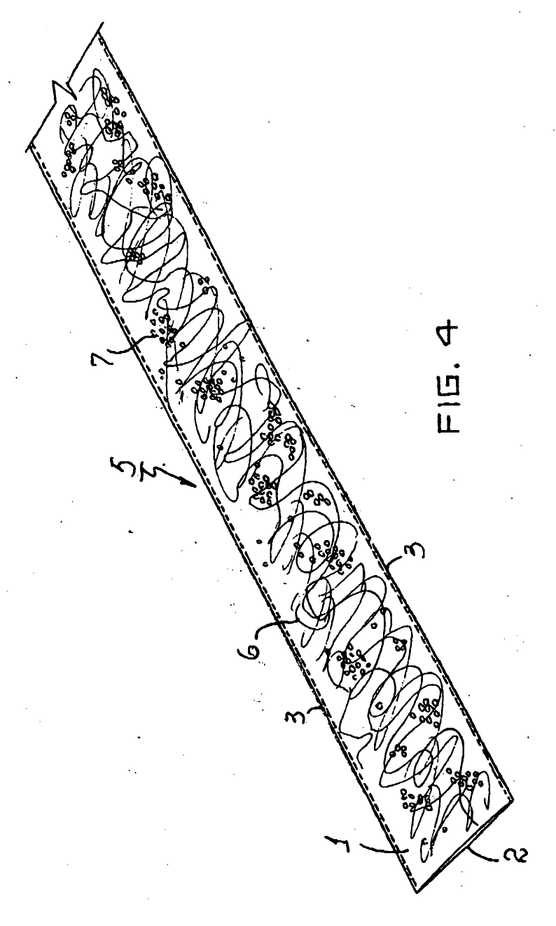

A variant of the first consolidation for the decorative and ornamental ribbons is shown in FIG. 4, where the final product 5 obtained in that first consolidation is characterized by containing an internal filling of fibers or natural textile threads, artificial or synthetic textile threads 6 applied by injection systems and/or natural seeds 7 through a turn table, or even paper, plastic and the like, luminous devices, such as incandescent lights, LEDs, optical fibers, etc.

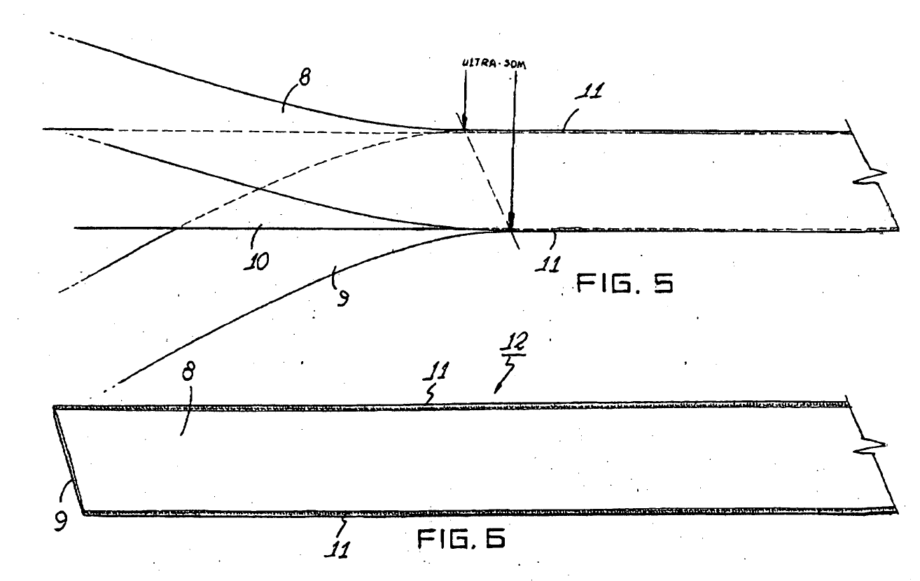

A second consolidation for the decorative and ornamental ribbons is shown in FIGS. 5 and 6. Two textile and/or thermoplastic plan sub-extracts strip cutting 8 and 9 are overlaid among themselves and having amongst them a plastic or similar structural element 10, all of which joined by the ultrasound welding system applied in their edges 11 or by any other possible process or mechanism (for example: gluing, etc.), and may or may not contain continuous metallic elements or textile threads between the welding.

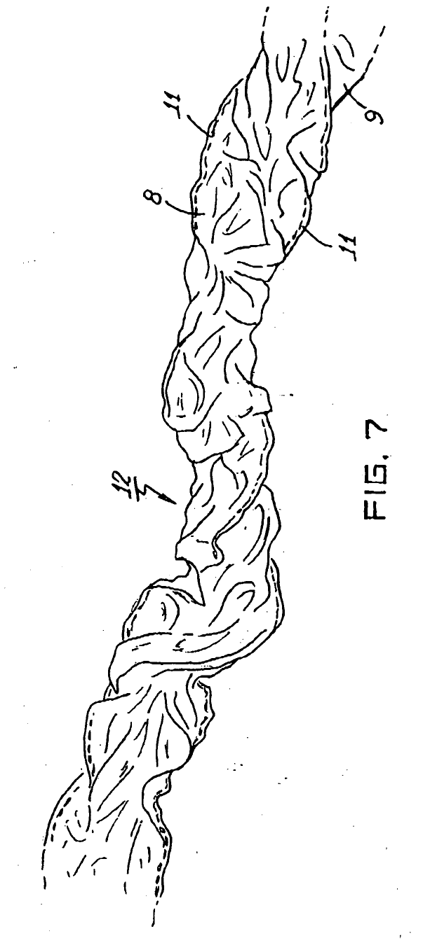

A variant of the second consolidation is represented in FIG. 7.

The final product 12 obtained in that consolidation is transformed when passing through a furnace, where the internal structured element 10 submitted to the heat tends to deform and shrink, forcing the external sub-extracts 8 and 9 to be transfigured in a wrinkled disposition with irregular or asymmetric pleats as shown in FIG. 7.

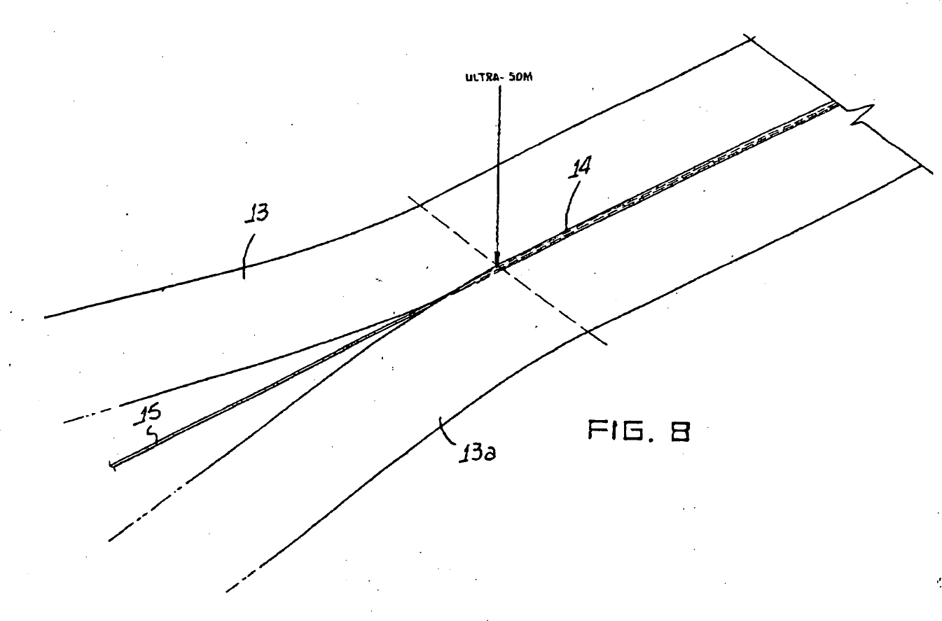

A third consolidation is shown in FIG. 8. In that consolidation two textile and/or thermoplastic plan sub-extracts strip cutting 13 and 13a are adjacently joined one to another in the longitudinal way, having the contact edges intimately joined by the ultrasound welding system 14 or by any other possible process or mechanism (for example: gluing, etc.), and may or may not include a continuous metallic element or textile thread 15 between the welding or other union mean.

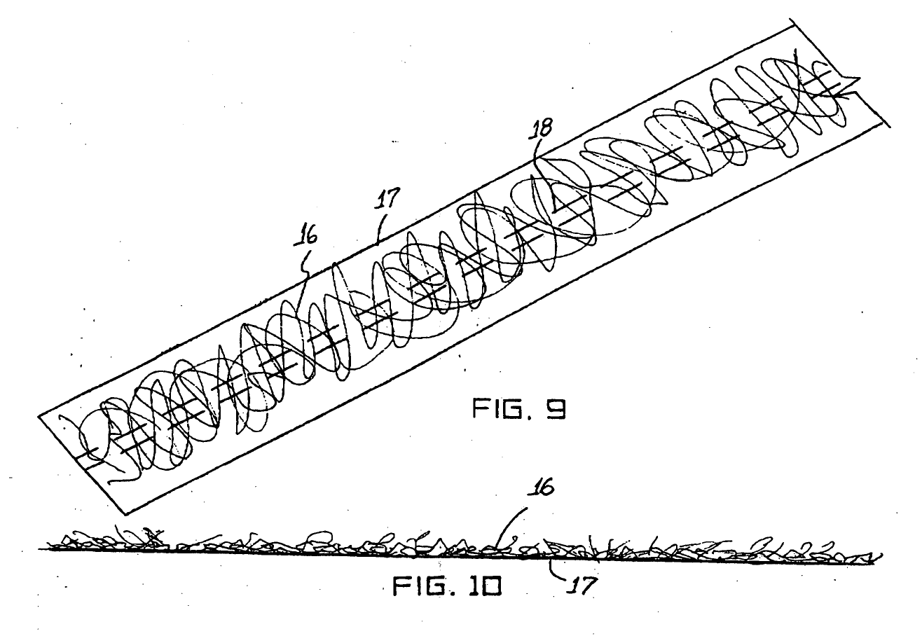

A fourth consolidation for the decorative and ornamental ribbons is shown in FIGS. 9 and 10. In that consolidation fibers or natural textile threads, artificial or synthetic textile threads 16, folded randomly and without a defined shape, are fixed through the ultrasound welding system 18 or by any other possible process or mechanism (for example: gluing, etc.) in the center and along a unique textile or thermoplastic plan sub-extract strip cutting 17.

What is claimed is:

1. Decorative and Ornamental Ribbons for Diverse Finalities characterized by a first consolidation comprising two textile and/or thermoplastic plan sub-extracts strip cutting (1) and (2) that are overlaid and edge joint among themselves by the ultrasound welding system (3), or any other possible process or mechanism (for example: gluing, etc.), and can contain one or more continuous metallic elements or textile threads (4) between the welding.

2. Decorative and Ornamental Ribbons for Diverse Finalities in accordance with the claim 1, characterized by a variant of the first consolidation, where the final product (5) obtained in that first consolidation contains an internal filling of fibers or natural, artificial or synthetic textile threads (6) applied by injection systems and/or natural seeds (7) through a turn table, or even paper, plastic and similars, luminous devices, such as incandescent lights, leds, optical fiber, etc.

3. Decorative and Ornamental Ribbons for Diverse Finalities in accordance with the claim 1, characterized by a second consolidation comprising two textile and/or thermoplastic plan sub-extracts strip cutting (8) and (9) overlaid among themselves and having amongst them a plastic or similar structural element (10), all of which joint by the ultrasound welding system or by any other possible process or mechanism (for example: gluing, etc.), applied in their edges (11) and can contain or not continuous metallic elements or textile threads between the welding.

4. Decorative and Ornamental Ribbons for Diverse Finalities in accordance with the claim 1, characterized by a variant of the second consolidation in which the final product (12) obtained in that consolidation is transformed when passing through a furnace, where the internal element (10) submitted to the heat tends to deform and shrink, forcing the external sub-extracts (8) and (9) to be transfigured in a wrinkled disposition with irregular or asymmetric pleats.

5. Decorative and Ornamental Ribbons for Diverse Finalities in accordance with the claim 1, characterized by a third consolidation in which two textile and/or thermoplastic plan sub-extracts strip cutting (13) and (13a) are adjacently joint one to another in the longitudinal way, having the contact edges intimately joint by the ultrasound welding system (14) or by any other possible process or mechanism (for example: gluing, etc.), and can have included or not a continuous metallic element or textile thread (15) between the welding.

6. Decorative and Ornamental Ribbons for Diverse Finalities in accordance with the claim 1, characterized by a fourth consolidation where fibers or natural, artificial or synthetic textile threads (16) folded randomly and without a defined shape are fixed through the ultrasound welding system (18), or by any other possible process or mechanism (for example: gluing, etc.) in the center and along an unique textile or thermoplastic plan sub-extract strip cutting (17).
